(19) United States
(12) Patent Application Publication
(10) Pub. No.: US 2004/0176944 A1
(43) Pub. Date: Sep. 9, 2004

(54) Composite apparatus having a multiple of functions

(75) Inventors: Tatsuo Noda, Nishinomiya-shi (JP); Yoshiyuki Fujiwara, Matsubara-shi (JP); Kiyoshi Hori, Kobe-shi (JP)

Correspondence Address: JORDAN AND HAMBURG LLP, 122 EAST 42ND STREET, SUITE 4000, NEW YORK, NY, 10168, US

(73) Assignee: Kyocera Mita Corporation, Osaka-shi (JP)

(21) Appl. No.: 10/382,067

(22) Filed: Mar. 5, 2003

(51) Int. Cl. G06F 17/28; G06F 17/27; H04M 11/00; H04M 1/00

(52) U.S. Cl. 704/3; 379/912; 379/440; 379/100.17; 704/9

(57) ABSTRACT

A composite apparatus having a display device and communicably connected with a client terminal is provided with a storage for storing character code tables corresponding to a plurality of character code formats; a communication controller for receiving a character data transmitted from the client terminal and a code information representing the character code format of the character data; and a display controller for displaying the character data received by the communication unit on the display device by referring to the character code table corresponding to the character code format of the received character data and stored in the storage.

### BACKGROUND OF THE INVENTION

1. Field of the Invention

This invention relates to a composite apparatus provided with a multiple of functions, such as scanner function, facsimile function, printer function, copier function and the like.

2. Description of the Related Art

In recent years, a composite apparatus provided with a scanner function, a facsimile function, a printer function, a copier function and the like has been widely used as a network printer of internal LAN.

Such a composite apparatus has a function of obtaining a list of communication addresses (addresses of other client terminals, electronic mail addresses, telephone numbers, etc.) stored in client terminals connected with an internal LAN, and displaying it on a display device provided therein. An operator can select a desired communication address in the displayed address information list and transmit various data to a client terminal having the selected communication address.

However, if different languages are set in the composite apparatus and a client terminal, there is a problem that an address list of the client terminal is displayed with character conversion when this list is displayed on the display device of the composite apparatus. For example, in the case where the language set in the composite apparatus is Japanese and a client terminal is English, the communication address list is properly displayed in the client terminal as shown in FIG. 12, but is displayed with character conversion in the composite apparatus as shown in FIG. 13.

The above composite apparatus also has a function of transmitting images read by means of a scanner to the client terminals and storing such an image in the client terminals. With such a function, the operator can input character data by means of soft keyboard displayed on the display device of the composite apparatus and transmit the inputted character data to the client terminals as a file name of an image data read by means of a scanner or the like.

However, the mother tongue of a user of the client terminal is generally set as a language in each client terminal, and the same language is not necessarily set in all the client terminals connected with the internal LAN. Thus, if different languages are set in the client terminal and the composite apparatus, character data inputted in the composite apparatus may be displayed while being replaced by other characters, i.e., the so-called character conversion may occur in the client terminal. In such a case, the file name attached to the image data is not properly displayed on the display device of the client terminal, and the user of the client terminal cannot distinguish the received image data.

### SUMMARY OF THE INVENTION

It is an object of the present invention to provide a composite apparatus having a multiple of functions which is free from the problems residing in the prior art.

According to an aspect of the present invention, a composite apparatus comprises a display device, a storage for storing character code tables corresponding to a plurality of character code formats, a communication unit communicatable with a client terminal and adapted for receiving character data and a code information representing the character code format of the character data from the client terminal, and a display controller for controlling the display device to display the character data received by the communication unit by referring to the character code table corresponding to the character code format of the received character data and stored in the storage.

With this construction, data transmitted from the client terminal is properly displayed on the display device of the composite apparatus without character conversion, and data inputted from the composite apparatus is properly displayed on a display device of the client terminal without character conversion even if different character code formats are set in the composite apparatus and the client terminal.

These and other objects, features, aspects, and advantages of the present invention will become more apparent from the following detailed description of the preferred embodiments/examples with reference to the accompanying drawings.

### BRIEF DESCRIPTION OF THE DRAWINGS

FIG. 1 is a block diagram showing a construction of a network system including a composite apparatus according to an embodiment of the invention;

FIG. 2A is a block construction diagram of a client terminal of the network system;

FIG. 2B is a block construction diagram of a character code terminal of the network system;

FIG. 2C is a block construction diagram of a keyboard terminal of the network system;

FIG. 3 is a block diagram showing a construction of the composite apparatus;

FIG. 4 is a flowchart showing an operation sequence executed between the composite apparatus and a client terminal when the composite apparatus obtains a communication address list stored in the client terminal;

FIG. 5 is a flowchart showing “Downloading” of the operation sequence shown in FIG. 4;

FIG. 6 is a flowchart showing a modification of the operation sequence shown in FIG. 4;

FIG. 7 is a flowchart showing another modification of the operation sequence shown in FIG. 4;

FIG. 8 is a flowchart showing an operation sequence of displaying a soft keyboard on an operation display device of the composite apparatus;

FIG. 9 is a diagram showing an exemplary soft keyboard displayed on the operation display device;

FIG. 10 is a flowchart showing “downloading” executed in the operation sequence shown in FIG. 8;

FIG. 11 is a flowchart showing a modification of the operation sequence shown in FIG. 8;

FIG. 12 is a diagram showing the communication address list properly displayed in the PC; and

FIG. 13 is a diagram showing the communication address list displayed in the composite apparatus with character conversion.

### DETAILED DESCRIPTION OF A PREFERRED EMBODIMENT OF THE INVENTION

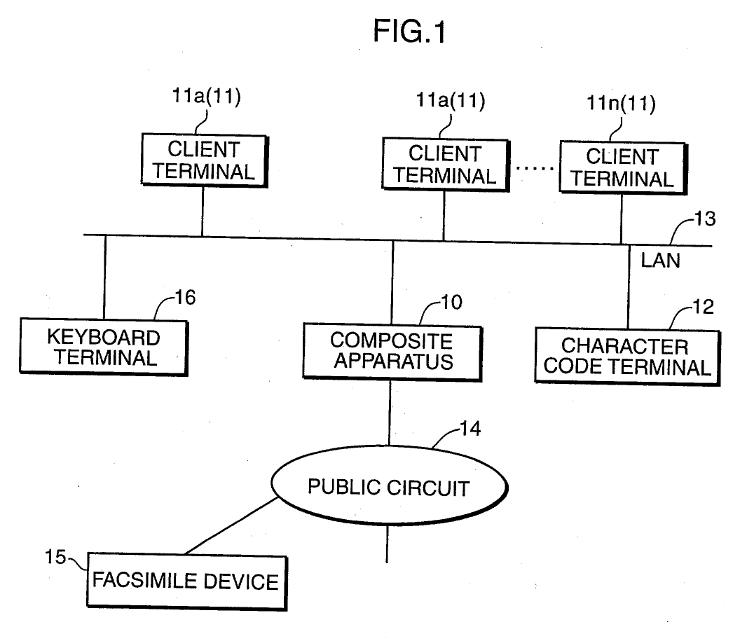

Referring to FIG. 1 showing a construction of a network system using a composite apparatus according to an embodiment of the invention, this network system includes a composite apparatus 10, a number of client terminals 11a to 11n (n is an integer), a character code terminal 12 and a keyboard terminal 16. The client terminals 11a to 11n and the composite apparatus 10 are so connected via a LAN (Local Area Network) 13 as to enable communications therebetween. The composite apparatus 10 is so connected with a facsimile apparatus 15 via a public circuit 14 as to enable communications therewith.

The client terminals 11a to 11n, the character code terminal 12 and the keyboard terminal 16 each are constructed by a usual personal computer.

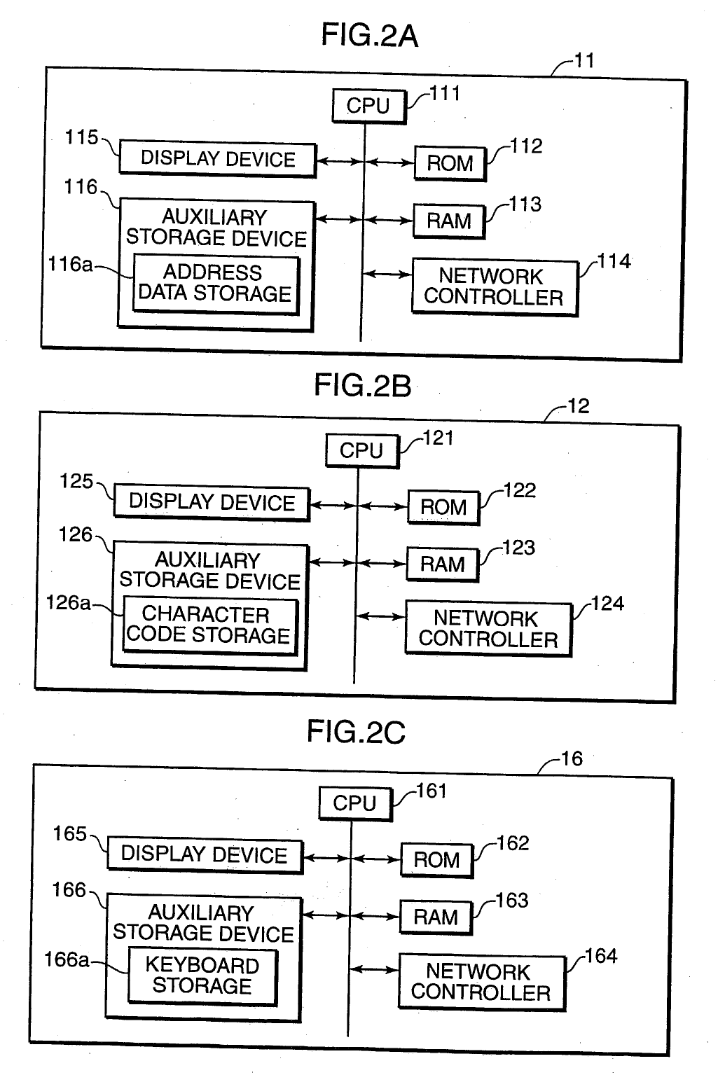

As shown in FIG. 2A, the client terminal 11 is provided with a CPU 111, a ROM 112, a RAM 113, a network controller 114, a display device 115 and an auxiliary storage device 116. A BIOS (basic input/output system) is stored in the ROM 112. The RAM 113 is used as a work area of the CPU 111 and various data are temporarily stored therein. The network controller 114 is constructed by a network interface (10/100BASE-T-TX) and the like, and controls the transmission and reception of various data to and from the other client terminals 11 or the composite apparatus 10 connected via the LAN 13. In the case of transmitting a character data, the network controller 114 transmits a code information representing the character code format of the character data while attaching it to the character data in accordance with the control by the CPU 111.

The display device 115 is constructed by a liquid crystal panel or a CRT (cathode-ray tube), and displays various data in accordance with the control by the CPU 111. The auxiliary storage device 116 is provided with an address data storage 116a for storing an operating system and storing a list of communication addresses (i.e., communication address list) such as electronic mail address of the other client terminals 11 and the facsimile number of the facsimile apparatus 15 the user of the client terminal 11 has registered.

As shown in FIG. 2B, the character code terminal 12 has substantially the same construction as the client terminal 11 and is provided with a CPU 121, a ROM 122, a RAM 123, a network controller 124, a display device 125 and an auxiliary storage device 126. Character code tables corresponding to a plurality of character code formats are stored in the auxiliary storage device 126. The character code tables are described later.

As shown in FIG. 2C, the keyboard terminal 16 has substantially the same construction as the client terminal 11 and is provided with a CPU 161, a ROM 162, a RAM 163, a network controller 164, a display device 165 and an auxiliary storage device 166. Soft keyboards corresponding to a plurality of character code formats are stored in the auxiliary storage device 166. The soft keyboards are described later.

One personal computer may serve both as the character code terminal 12 and as the keyboard terminal 16. In such a case, the auxiliary storage device of this personal computer includes a character code storage and a keyboard data storage. Alternatively, one personal computer may serve as the client terminal 11, as the character code terminal 12 and as the keyboard terminal 16. In such a case, the auxiliary storage device of this personal computer includes an address data storage, a character code storage and a keyboard data storage.

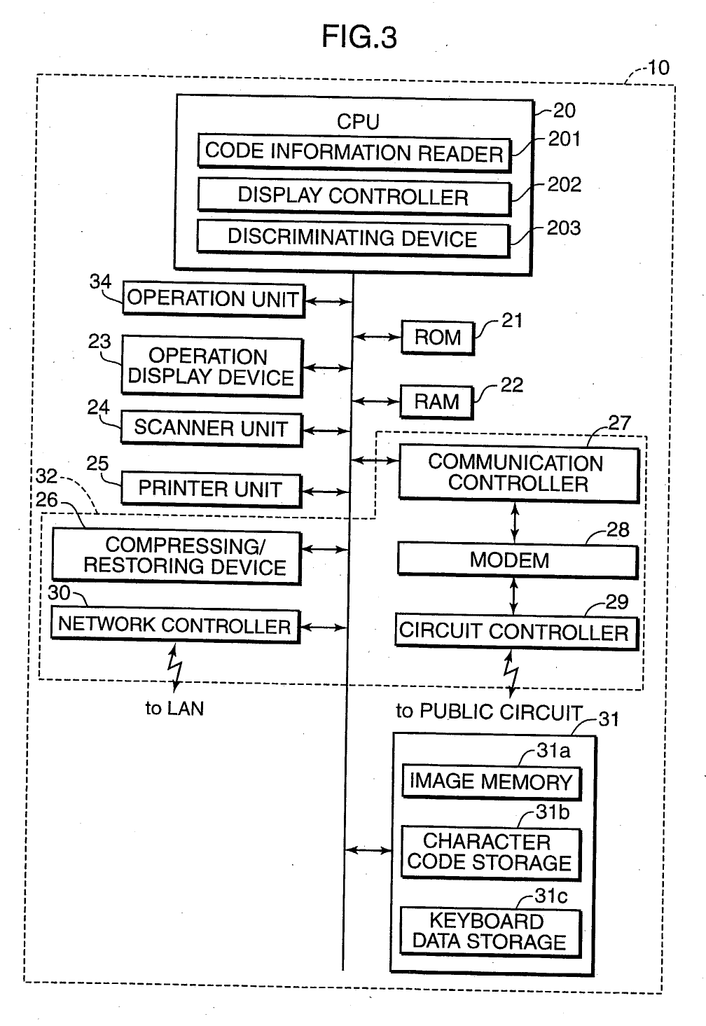

Referring now to FIG. 3 showing a construction of the composite apparatus 10, the composite apparatus 10 is provided with a CPU 20, a ROM 21, a RAM 22, an operation display device 23, a scanner unit 24, a printer unit 25, an auxiliary storage device (storage) 31 and a communication unit 32.

Various control programs used to control the composite apparatus 10 are stored in the ROM 21. The RAM 22 is used as a work area of the CPU 20 and various data are temporarily stored therein. The operation display device 23 displays various data representing the operative state of the composite apparatus 10 and the like in accordance with the control of the CPU 20.

The auxiliary storage device 31 is formed, for example, by a hard disk and includes an image memory 31a, a character code storage 31b and a keyboard data storage 31c. The image memory 31a is adapted to store a document data read by the scanner unit 24, a print data transmitted from the client terminal 11 via the LAN 13, and a facsimile data transmitted from the facsimile device 15 via the public circuit 14.

The character code storage 31b is adapted to store character code tables corresponding to a plurality of character code formats. The character codes are codes of characters constructing various languages such as Japanese and English. The character code tables are tables defining correspondences between the character codes and the characters represented by these character codes. Further, the character code formats are one or a plurality of existing various code systems for the language of each country. For example, JIS Kanji-codes and the like fall within the category of the character code format.

The keyboard data storage 31c is adapted to store the soft keyboards corresponding to a plurality of character code formats. Soft keyboards are those virtually displayed on a liquid crystal display or the like, and various data are inputted when a user touches this keyboard on the liquid crystal panel.

The CPU 20 functions as a code information reader 201, a display controller 202 and a discriminating device 203 by executing various control programs stored in the ROM 21.

The code information reader 201 reads the character code format of the received character data based on a code information attached to the character data transmitted from the client terminal 11.

The display controller 202 reads the character code table corresponding to the character code format read by the code information reader 201 from the character code storage 31b, and displays the character data received from the client terminal 11 on the operation display device 23 using the read character code table. The display controller 202 also reads the soft keyboard corresponding to the character code format read by the code information reader 201 from the keyboard data storage 31c and displays it on the operation display device 23.

The discriminating device 203 discriminates whether or not the character code table or the soft keyboard corresponding to the character code format read by the code information reader 201 is stored in the character code storage 31b or the keyboard data storage 31c.

The scanner unit 24 includes an exposure lamp and CCDs (charge-coupled devices), reads an image of a document by illuminating the document by means of the exposure lamp and receiving the light reflected by the document by means of the CCDs, and outputs the read data to the image memory 31a.

The printer unit 25 includes a sheet transporting mechanism, a photosensitive drum, an exposing device, a developing device, etc. and prints an image on a recording sheet using a document data read by the scanner unit 24, a print data transmitted from the client terminal 11 via a network controller 30, a facsimile data transmitted from the facsimile device 15 via a circuit controller 29 or the like.

The communication unit 32 includes a compressing/restoring device 26, a communication controller 27, a modem 28, the circuit controller 29 and the network controller (communication controller) 30. The compressing/restoring device 26 encodes and compresses character data to be transmitted and those received. The communication controller 27 controls the transmission and reception of data between communication devices connected via the public circuit 14. The modem 28 modulates an image data into a sound signal and a received signal (sound signal) into an image data. The circuit controller 29 controls connection with the facsimile device 15 and the like as a transmission end via a telephone circuit. The network controller 30 is formed, for example, by a network interface (10/100BASE-T-TX), and controls the transmission and reception of various data to and from the client terminals 11 connected via the LAN 13, for example, to transmit a document image read by the scanner unit 24 to the client terminals 11.

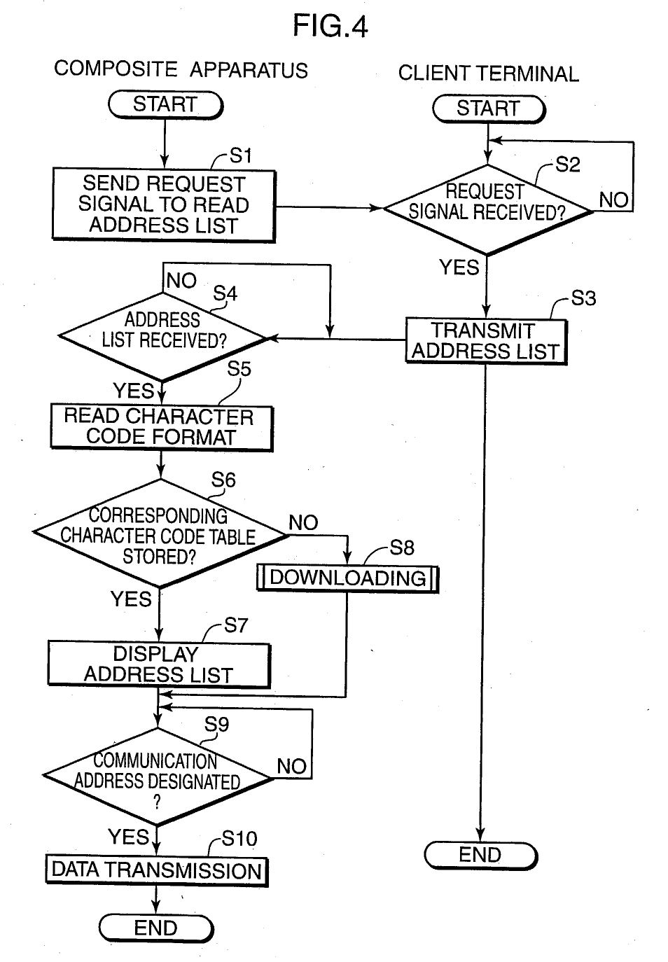

FIG. 4 is a flowchart showing an operation sequence executed between the composite apparatus 10 and the client terminal 11 when the composite apparatus 10 obtains a communication address list stored in the client terminal 11. First, in Step S1, when an operator designates the client terminal 11 from which the communication address list is to be read by means of an operation unit 34 of the composite apparatus 10, the composite apparatus 10 sends a request signal to the client terminal 11 to read the communication address list.

Upon receiving the request signal (YES in Step S2), the client terminal 11 reads the communication address list from the address data storage 116a and transmits it to the composite apparatus 10 via the network controller 114 (Step S3). The network controller 114 of the client terminal 11 transmits the code information representing the character code format of the character data used to express the communication address list together with the communication address list.

When the composite apparatus 10 receives the communication address list (YES in Step S4), the code information reader 201 of the composite apparatus 10 reads the character code format of the character data of the communication address list from the received code information in Step S5.

In Step S6, the discriminating device 203 discriminates whether or not the character code table corresponding to the character code format read by the code information reader 201 is stored in the character code storage 31b. If the discriminating device 203 judges that the corresponding character code table is stored in the character code storage 31b (YES in Step S6), the display controller 202 controls the display device 23 to display the communication address list using the corresponding character code table (Step S7).

On the other hand, if the discriminating device 203 judges that the corresponding character code table is not stored in the character code storage 31b (NO in Step S6), the composite apparatus 10 downloads the corresponding character code table from the character code terminal 12 (Step S8). The downloaded character code table is stored, for example, in the RAM 22. This operation is described later.

In Step S9, the operator designates one or more communication addresses from the communication address list displayed on the operation display device 23 and an image data to be transmitted by means of the operation unit 34, the composite apparatus 10 reads the image data to be transmitted from the image memory 31a and transmits it to the client terminal(s) 11 and/or the facsimile device 15 having the designated communication address(es) (Step S10).

Since the display controller 202 controls the display device 23 to display the communication address list transmitted from the client terminal 11 in the character code format set in the client terminal 11, the received communication address list can be properly displayed without character conversion on the operation display device 23 of the composite apparatus 10 even if the character code formats set in the composite apparatus and the client terminal 11 differ.

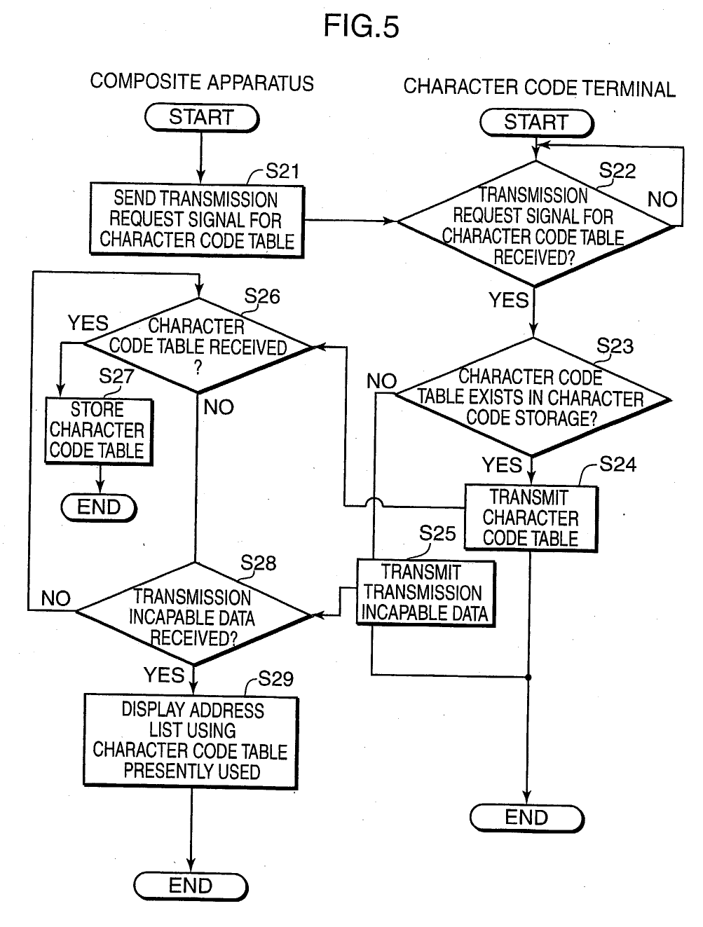

Referring to FIG. 5 showing a subroutine “Downloading” executed in Step S8 of the flowchart shown in FIG. 4, first, in Step S21, the composite apparatus 10 sends a transmission request signal requesting the transmission of the character code table to the character code terminal 12. This transmission request signal contains a code information representing the character code format of the character code table requested to the character code terminal 12 to transmit.

Receiving the transmission request signal (YES in Step S22), the character code terminal 12 discriminates whether or not the character code table corresponding to the character code format represented by the code information is stored in the character code storage 126a in Step S23.

If the requested character code table exists in the character code storage 126a (YES in Step S23), the character code terminal 12 reads the requested character code table from the character code storage 126a and transmits it to the composite apparatus 10 via the network controller 30 (Step S24). On the other hand, if the requested character code table does not exist in the character code storage 126a (NO in Step S23), the character code terminal 12 sends a transmission incapable data representing that the character code table cannot be transmitted to the composite apparatus 10 (Step S25).

The composite apparatus 10 having received the character code table from the character code terminal 12 (YES in Step S26) stores the received character code table, for example, in the RAM 22 (Step S27). In the case of downloading the character code table, the composite apparatus 10 additionally stores the character code table in the RAM 22 if there is a sufficient space capacity. On the other hand, if the RAM 22 has no sufficient space capacity, the composite apparatus 10 stores the downloaded character code table after deleting any one of the character code tables stored in the RAM 22. In such a case, it is desirable to delete a character code table used with a low frequency.

If the composite apparatus 10 receives the transmission incapable data from the character code terminal 12 (YES in Step S28), the display controller 202 causes the communication address list to be displayed on the operation display device 23 using the presently used character code table (Step S29). In this way, the communication address list is displayed on the operation display device 23 using certain characters. In this case, the communication address list may be displayed with character conversion on the operation display device 23, but the displayed communication address list may contain characters properly displayed depending on a relationship between the character code format of the communication address list and the character code format used to express this communication address list in the composite apparatus 10. As a result, an operator may recognize the communication address list displayed on the operation display device 23.

Instead of using the presently used character code table, a character code format most approximate to the character code format of the communication address list may be selected and the communication address list may be displayed using the selected character code format. Further, in the case of such a notification that the character code table cannot be transmitted, the composite apparatus 10 may display, for example, a message “Communication address list cannot be displayed” without displaying the communication address list.

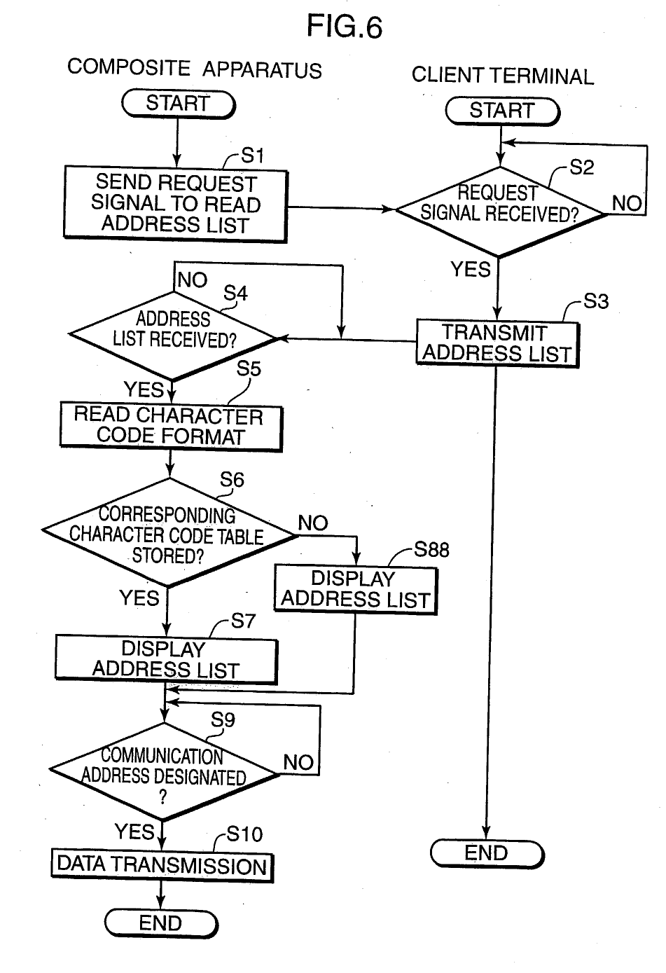

FIG. 6 shows a modification of the operation sequence shown in FIG. 4. The operation sequence shown in FIG. 6 has the same operation steps as that of FIG. 4 except a step of displaying address list using a character code table which the composite apparatus 10 has instantly used (in Step S88) instead of the downloading in Step 8 of the operation sequence shown in FIG. 4. Accordingly, even if the character code formats set in the client terminal 11 and the composite apparatus 10 differ, the received character data can be displayed on the operation display device 23 of the composite apparatus 10 using certain characters.

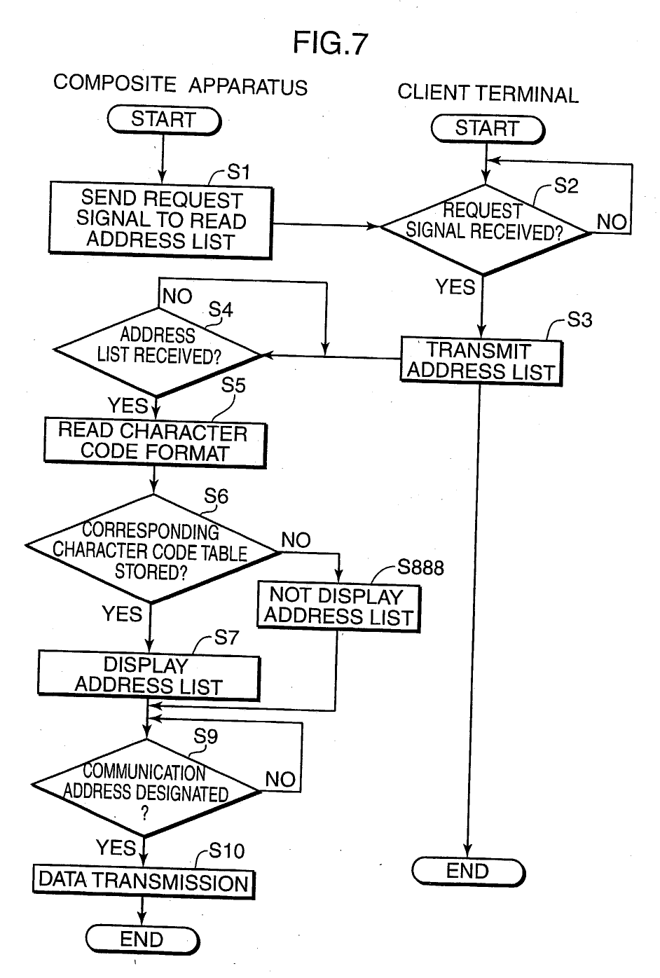

FIG. 7 shows a modification of the operation sequence shown in FIG. 4. The operation sequence shown in FIG. 7 has the same operation steps as that of FIG. 4 except a step of not displaying address list (in Step S888) instead of the downloading in Step 8 of the operation sequence shown in FIG. 4. In this operation sequence, the display of the communication address list with character conversion on the operation display device 23 of the composite apparatus 10 can be securely prevented.

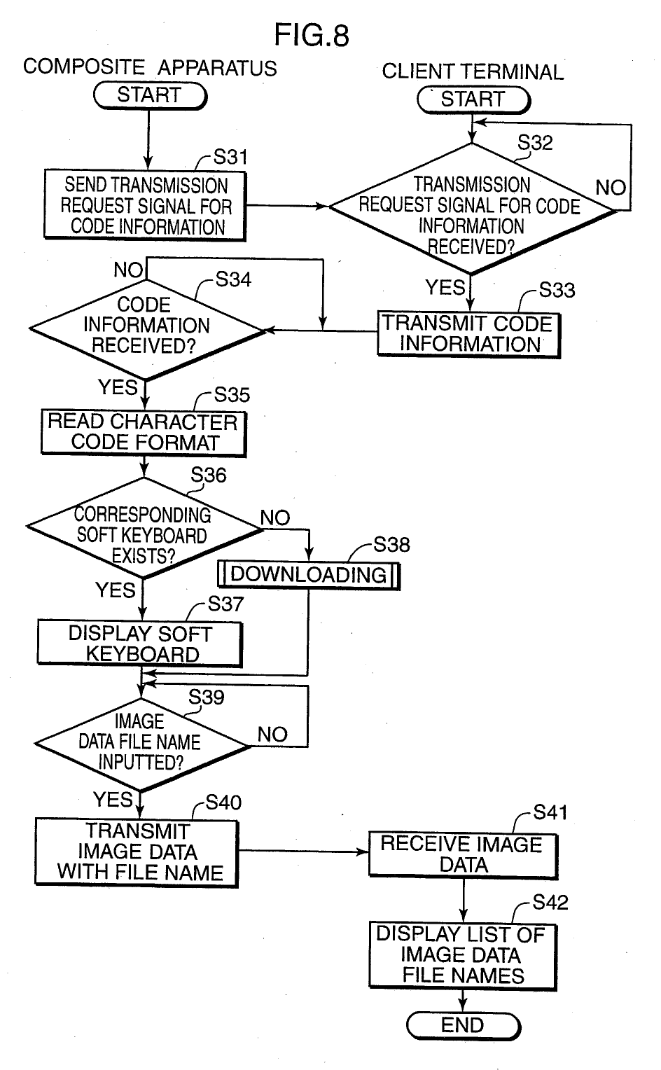

FIG. 8 is a flowchart showing an operation sequence executed until the soft keyboard is displayed on the operation display device 23 of the composite apparatus 10. First, in Step S31, the composite apparatus 10 sends a transmission request signal requesting the transmission of a code information to the client terminal 11. Upon receiving the transmission request signal (YES in Step S32), the client terminal 11 sends a code information representing the character code format set in the client terminal 11 to the composite apparatus 10 (Step S33). If the composite apparatus 10 receives the code information (YES in Step S34), the code information reader 201 reads the character code format represented by the received code information (Step S35).

If the discriminating device 203 judges that a soft keyboard corresponding to the character code format represented by the received code information is stored in the keyboard data storage 31c (YES in Step S36), the display controller 202 reads the soft keyboard from the keyboard data storage 31c and displays it on the operation display device 23 (Step S37).

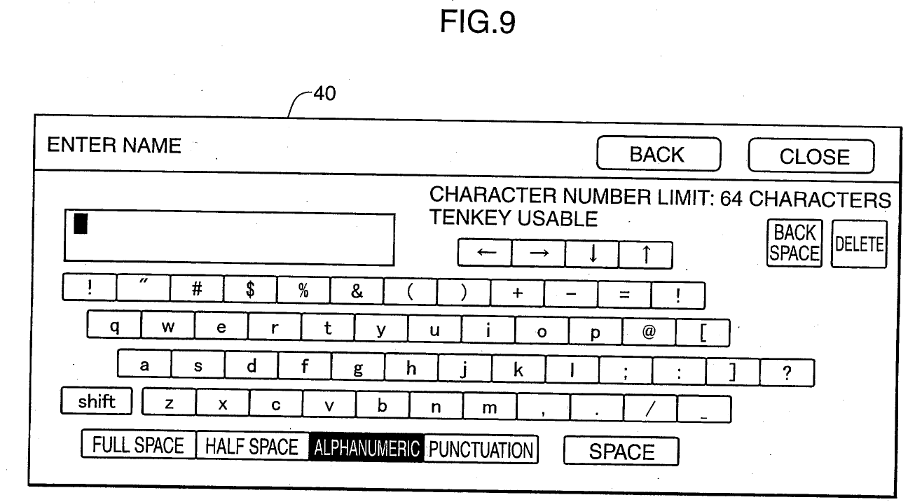

FIG. 9 is a diagram showing an exemplary soft keyboard to be displayed on the operation display device 23. This soft keyboard is an English soft keyboard displayed on the operation display device 23 when the language set in the composite apparatus 10 is Japanese and a client terminal 11 is English.

On the other hand, if the discriminating device 203 judges that the corresponding soft keyboard is not stored in the keyboard data storage 31c (NO in Step S36), the corresponding soft keyboard is downloaded from the keyboard terminal 16 (Step S38). The downloaded soft keyboard is stored, for example, in the RAM 22. In the case of newly downloading the soft keyboard, this soft keyboard may be additionally stored in the RAM 22 if the RAM 22 has a sufficient space capacity. If the RAM 22 has no sufficient space capacity, the downloaded soft keyboard may be stored after deleting any one of the existing soft keyboards. In such a case, it is desirable to delete a soft keyboard used with a low frequency.

Two or more kinds of characters may be simultaneously displayed on each key of the soft keyboard. In this case, it is preferable to display the character corresponding to the language set in the composite apparatus 10 and the one corresponding to the language set in the client terminal 11 presently in communication with the composite apparatus 10.

Subsequently, when a user designate an image data to be transmitted (document data read by the scanner unit 24), a facsimile data transmitted from the facsimile device 15, an image data transmitted from the client terminal 11 or the like), inputs the file name of the image data to be transmitted by means of the soft keyboard displayed on the operation display device 23 and presses a “start button” (not shown) included in the soft keyboard (YES in Step S39), the composite apparatus 10 transmits the designated image data while attaching the inputted file name thereto (Step S40).

In Step S41, the client terminal 11 having received the image data transmitted from the composite apparatus 10 stores this data in a specified directory of the auxiliary storage device 116. When a user of the client terminal 11 refers to the directory of the received image data, the client terminal 11 displays a list of the file names of the image data stored in this directory on the display device 115 (Step S42).

In the composite apparatus 10, since the file name attached to the image data is a character data inputted using the soft keyboard corresponding to the character code format used in the client terminal 11, the file name of the image data experiences no character conversion upon being displayed in the client terminal 11.

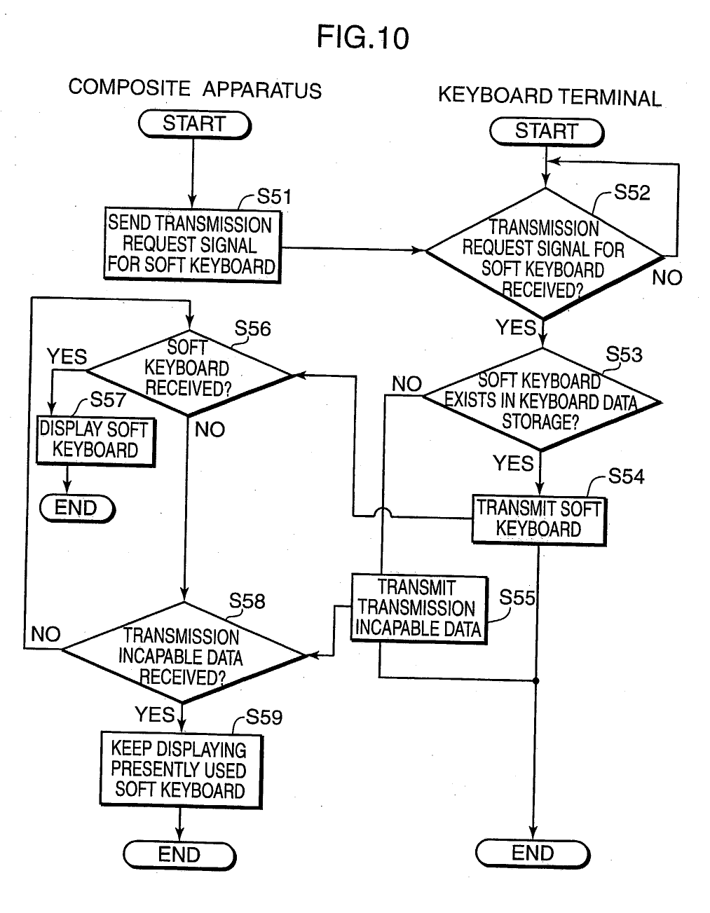

FIG. 10 is a flowchart showing a subroutine “downloading” executed in Step S38. First, in Step S51, the composite apparatus 10 sends a transmission request signal requesting the transmission of a soft keyboard to the keyboard terminal 16. This transmission request signal contains a code information representing the character code format of the requested soft keyboard. In Step S42, when the keyboard terminal 16 receives the transmission request signal, the keyboard terminal 16 discriminates whether or not a soft keyboard corresponding to the character code format represented by the code information is stored in the keyboard data storage 166a (Step S53). The keyboard terminal 16 transmits the corresponding soft keyboard to the composite apparatus 10 (Step S54) if the corresponding soft keyboard is stored in the keyboard data storage 166a (YES in Step S53).

On the other hand, if the corresponding soft keyboard is not stored in the keyboard data storage 166a (NO in Step S53), the keyboard terminal 16 transmits a transmission incapable data representing that the soft keyboard cannot be transmitted to the composite apparatus 10 (Step S55).

If the composite apparatus 10 receives the soft keyboard (YES in Step S56), the display controller 202 displays the received soft keyboard on the operation display device 23 (Step S57). On the other hand, if the composite apparatus 10 receives the transmission incapable data instead of receiving the soft keyboard (NO in Step S56 and YES in Step S58), the display controller 202 displays the soft keyboard being presently used as it is on the operation display device 23 (Step S59). In such a case, a message saying that the soft keyboard cannot be displayed may be displayed on the operation display device 23 instead of displaying the soft keyboard being presently used on the operation display device 23.

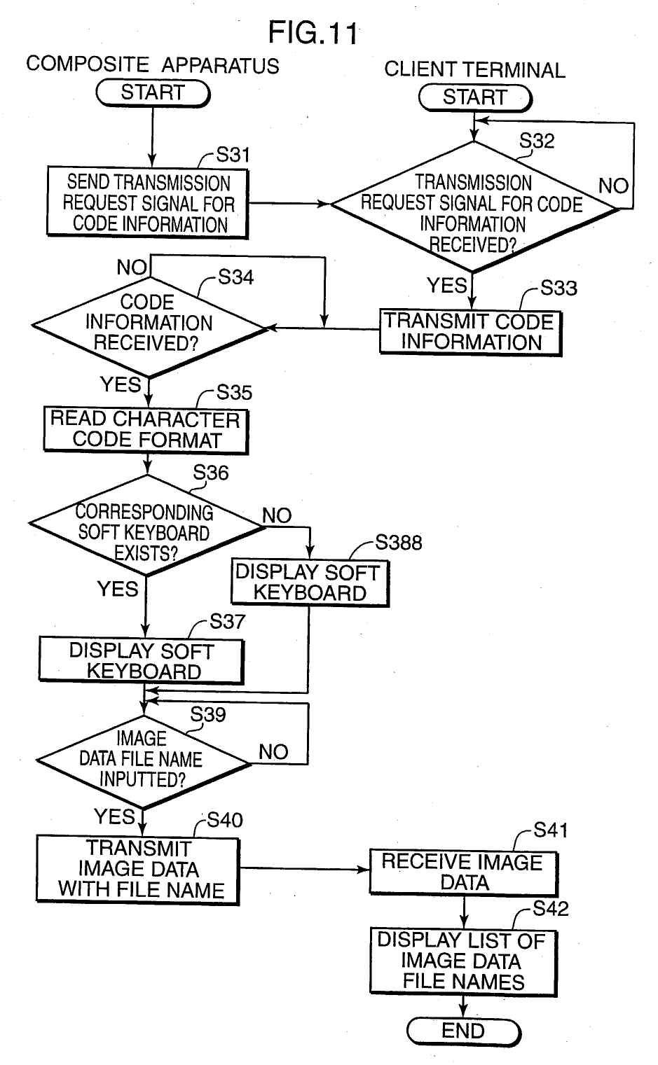

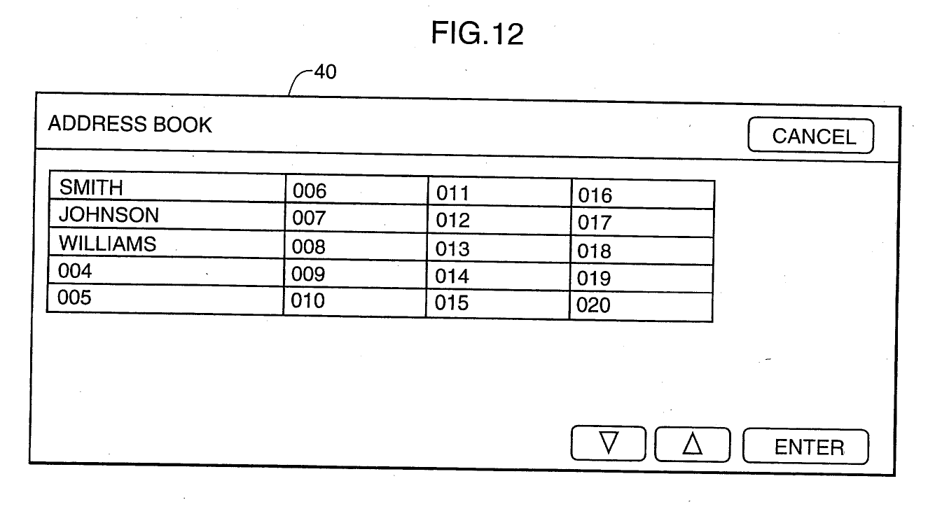

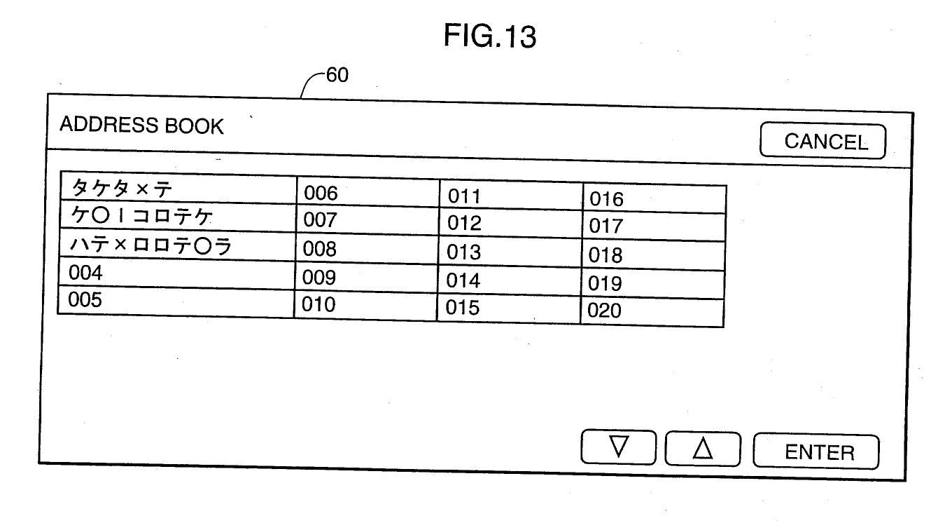

FIG. 11 shows a modification of the operation sequence shown in FIG. 8. The operation sequence shown in FIG. 11 has the same operation steps as that of FIG. 8 except a step of displaying the soft keyboard using the presently used soft keyboard instead of the downloading in Step 38 of the operation sequence shown in FIG. 8. Accordingly, even if the character code formats set in the client terminal 11 and the composite apparatus 10 differ, a certain soft keyboard can be displayed on the operation display device 23 of the composite apparatus 10.

As described above, when the character data outputted from the client terminal 11 and the code information representing the character code format of the character data are received, the character code table corresponding to the character code format represented by this code information is read from the character code storage 31b and the received character data is displayed on the operation display device 23 using this character code table. Thus, even if the character code formats set in the client terminal 11 and the composite apparatus 10 differ (for example, even if English is set in the client terminal 11 and Japanese is set in the composite apparatus 10), the character data transmitted form the client terminal 11 can be displayed without character conversion on the operation display device 23 of the composite apparatus 10.

Further, even if the character code formats set in the client terminal 11 and the composite apparatus 10 differ, the soft keyboard in accordance with the character code format set in the client terminal 11 is displayed on the operation display device 23 of the composite apparatus 10 and the character data inputted by means of this soft keyboard is outputted to the client terminal 11 while the character code format is kept. Thus, the character data inputted by means of the soft keyboard can be displayed without character conversion on the display device 115 of the client terminal 11.

If the character code table used to express the character data transmitted from the client terminal 11 is not stored in the character code storage 31b of the composite apparatus 10, the character data transmitted from the client terminal 11 or the soft keyboard is displayed in accordance with the character code table used at the time of receiving the character data (including the character code table of defaults displayed in the case that the character data has not been received even once). Thus, even if the character code formats set in the client terminal 11 and the composite apparatus 10 differ, the received character data or the soft keyboard can be displayed on the operation display device 23 of the composite apparatus 10 using certain characters.

If the character code table corresponding to the character data representing the communication address list transmitted from the client terminal 11 is not stored in the character code storage 31b of the composite apparatus 10, the display of the communication address list with character conversion on the operation display device 23 of the composite apparatus 10 can be securely prevented by taking such a mode as not to display the character data.

Even if the character code formats set in the client terminal 11 and the composite apparatus 10 differ and the character code table corresponding to the character code format set in the client terminal 11 is not stored in the composite apparatus 10, the corresponding character code table can be downloaded from the character code terminal 12. Thus, the communication address list outputted from the client terminal 11 can be displayed without character conversion on the operation display device 23 of the composite apparatus 10.

Even if the character code formats set in the client terminal 11 and the composite apparatus 10 differ and the soft keyboard corresponding to the character code format set in the client terminal 11 is not stored in the composite apparatus 10, the composite apparatus 10 can download the corresponding soft keyboard from the keyboard terminal 16 and display it on the operation display device 23. Thus, the soft keyboard corresponding to the character code format set in the client terminal 11 can be displayed on the operation display device 23 and the file name of the image data inputted by means of the soft keyboard can be transmitted to the client terminal 11 while this character code format is kept. Therefore, when the directory in which this image data is stored is referred to in the client terminal 11, the file name of this image data can be displayed without character conversion.

Further, the present invention is not limited to the above-described embodiment, the following modifications may be made.

(1) In the foregoing embodiment, the corresponding soft keyboard is downloaded by referring to the keyboard terminal 16 if no corresponding keyboard data exists in the composite apparatus 10. However, all the soft keyboards may be downloaded from the keyboard terminal 16. In such a case, the composite apparatus 10 needs not store the keyboard data.

(2) The corresponding character code table is downloaded by referring to the character code terminal 12 if no corresponding character code table exists in the composite apparatus 10 in the foregoing embodiment. However, all the character code tables may be stored in the character code terminal 12. In such a case, the composite apparatus 10 needs not store the character code tables.

(3) The keyboard terminal 16 and the character code terminal 12 are connected with the LAN 13 in the foregoing embodiment. However, either one or both of the keyboard terminal 16 and the character code terminal 12 may not be connected with the LAN 13.

(4) The soft keyboard is displayed on the operation display device 23 in the foregoing embodiment. However, the composite apparatus 10 may be provided with a special display panel for displaying the soft keyboard and the soft keyboard may be displayed on this special display panel.

(5) The composite apparatus 10 conducts a communication with the facsimile device 15 and the like using the modem 28 in the foregoing embodiment. However, if the public circuit 14 is a digital circuit such as an ISDN (Integrated Services Digital Network), the composite apparatus 10 may include a DSU (Digital Service Unit), a TA (Terminal Adapter), or the like instead of the modem 28.

(6) In the foregoing embodiment, the composite apparatus 10 sends the communication address list to the client terminal 11. The composite apparatus 10 may be connected with a client terminal 11 which stores a list of key words representing documents, such as product information, company profile, personnel information, news paper, to be handled by the composite apparatus. Specifically, the composite apparatus 10 obtains a key word list from the client terminal 11 and displays the key word list on the operation display device 23 of the composite apparatus 10 to enable the user to select among the key word list a key word suitable to represent a document handled by the composite apparatus 10. The composite apparatus sends the handled document together with the selected key word to the client terminal 11.

In this case, if the composite apparatus 10 and the client terminal 11 use different character codes, the composite apparatus 10 receives a code information representing the character code format of the client terminal, and displays key words in the character code table corresponding to the received code information. Consequently, the key words are displayed without character conversion.

Alternatively, it may be appreciated to enable the user to make a key word on the composite apparatus 10 instead of selecting a key word among the key word list provided from the client terminal 11. In this case, the operation display device 23 of the composite apparatus 10 may be displayed with a soft keyboard corresponding to the character code format of a client terminal 11 to which a handled document is to be sent to enable the user to make a key word using the soft keyboard. The key word made in this way has the same character code format as the client terminal 11. Accordingly, the key word is displayed on the client terminal 11 without character conversion.

As described above, an inventive composite apparatus is provided with: a display device; a storage which stores character code tables corresponding to a plurality of character code formats; a communication unit which is communicatable with a client terminal, and receives character data and a code information representing the character code format of the character data from the client terminal; and a display controller which controls the display device to display the character data received by the communication unit by referring to the character code table corresponding to the character code format of the received character data and stored in the storage.

With this construction, when the character data and the code information representing the character code format of this character data outputted from the client terminal are received, the character code table corresponding to the character code format represented by the code information is referred to and the received character data is displayed on the display device using this character code table. Thus, even if different character code formats are set in the client terminal and the composite apparatus (e.g. if English is set in the client terminal and Japanese is set in the composite apparatus), the character data transmitted from the client terminal can be displayed without character conversion on the display device of the composite apparatus.

It may be appreciated that the storage stores soft keyboards corresponding to the plurality of character code formats, and the display controller controls the display device to display a soft keyboard corresponding to the character code format represented by the code information received by the communication unit, and the communication unit transmits a character data inputted by the soft keyboard in the character code format of the soft keyboard to the client terminal.

With this construction, even if the character code formats set in the client terminal and the composite apparatus differ, the soft keyboard in accordance with the character code format set in the client terminal is displayed on the display device of the composite apparatus, and the character data inputted by means of the soft keyboard is outputted to the client terminal while the character code format is kept. Thus, the character data inputted by the soft keyboard can be displayed without character conversion on the display device of the client terminal.

The composite apparatus may be further provided with a discriminating device for discriminating whether or not a soft keyboard corresponding to a character code format represented by the code information received by the communication unit is stored in the storage

The display controller may control the display device to display a soft keyboard using the presently used soft keyboard if the discriminating device judges that the corresponding soft keyboard is not stored in the storage.

Also, the display controller may control the display device to display no soft keyboard if the discriminating device judges that the corresponding soft keyboard is not stored in the storage.

Further, the communication unit may be preferably communicatable with a soft keyboard storing terminal storing soft keyboards not stored in the storage, and downloads a corresponding soft keyboard from the soft keyboard storing terminal if the discriminating device judges that the soft keyboard is not stored in the storage. The display controller may control the display device to display the soft keyboard using the downloaded soft keyboard.

The composite apparatus may be further provided with a discriminating device for discriminating whether or not a character code table corresponding to the character code format represented by the code information received by the communication unit is stored in the storage. The display controller may control the display device to display character data received by the communication unit using the character code table used when the character data is received if the discriminating device judges that the corresponding character code table is not stored in the storage.

The display controller may control the display device not to display the character data received by the communication unit if the discriminating device judges that the corresponding character code table is not stored in the storage.

The communication unit may be preferably communicatable with a character code storing terminal storing character code tables of character code formats not stored in the storage, and downloads a corresponding character code table from the character code storing terminal if the discriminating device judges that the character code table is not stored in the storage. In this case, display controller may control the display device to display the character data received by the communication unit using the downloaded character code table.

This application is based on patent application Nos. 2002-061782 and 2002-061787 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A composite apparatus comprising:
a display device;
a storage which stores character code tables corresponding to a plurality of character code formats;
a communication unit which is communicatable with a client terminal, and receives character data and a code information representing the character code format of the character data from the client terminal; and
a display controller which controls the display device to display the character data received by the communication unit by referring to the character code table corresponding to the character code format of the received character data and stored in the storage.

2. A composite apparatus according to claim 1, wherein:
the storage further stores soft keyboards corresponding to the plurality of character code formats,
the display controller controls the display device to display a soft keyboard corresponding to the character code format represented by the code information received by the communication unit, and
the communication unit transmits character data inputted by the soft keyboard in the character code format of the soft keyboard to the client terminal.

3. A composite apparatus according to claim 2, further comprising a discriminating device which discriminates whether or not a soft keyboard corresponding to a character code format represented by the code information received by the communication unit is stored in the storage, wherein the display controller controls the display device to display a soft keyboard using the presently used soft keyboard if the discriminating device judges that the corresponding soft keyboard is not stored in the storage.

4. A composite apparatus according to claim 2, further comprising a discriminating device which discriminates whether or not a soft keyboard corresponding to a character code format represented by the code information received by the communication unit is stored in the storage, wherein the display controller controls the display device to display no soft keyboard if the discriminating device judges that the corresponding soft keyboard is not stored in the storage.

5. A composite apparatus according to claim 2, further comprising a discriminating device which discriminates whether or not a soft keyboard corresponding to a character code format represented by the code information received by the communication unit is stored in the storage, wherein:
the communication unit is communicatable with a soft keyboard storing terminal storing soft keyboards not stored in the storage, and downloads a corresponding soft keyboard from the soft keyboard storing terminal if the discriminating device judges that the soft keyboard is not stored in the storage, and
the display controller controls the display device to display the soft keyboard using the downloaded soft keyboard.

6. A composite apparatus according to claim 1, further comprising a discriminating device which discriminates whether or not a character code table corresponding to the character code format represented by the code information received by the communication unit is stored in the storage, wherein the display controller controls the display device to display character data received by the communication unit using the character code table used when the character data is received if the discriminating device judges that the corresponding character code table is not stored in the storage.

7. A composite apparatus according to claim 1, further comprising a discriminating device which discriminates whether or not a character code table corresponding to the character code format represented by the code information received by the communication unit is stored in the storage, wherein the display controller controls the display device not to display the character data received by the communication unit if the discriminating device judges that the corresponding character code table is not stored in the storage.

8. A composite apparatus according to claim 1, further comprising a discriminating device which discriminates whether or not a character code table corresponding to the character code format represented by the code information received by the communication unit is stored in the storage, wherein:
the communication unit is communicatable with a character code storing terminal storing character code tables of character code formats not stored in the storage, and downloads a corresponding character code table from the character code storing terminal if the discriminating device judges that the character code table is not stored in the storage, and
the display controller controls the display device to display the character data received by the communication unit using the downloaded character code table.
